(19) United States
(12) Patent Application Publication
(10) Pub. No.: US 2009/0274131 A1
(43) Pub. Date: Nov. 5, 2009

(54) METHOD AND SYSTEM FOR DYNAMIC DISTRIBUTION OF TRAFFIC IN CHANNEL BONDING WIRELESS LOCAL AREA NETWORK(LAN) SYSTEMS

(75) Inventors: Youngseok LEE, Yuseong-gu (KR); Ji Ook KIM, Seo-gu (KR)

Correspondence Address: STAAS & HALSEY LLP, SUITE 700, 1201 NEW YORK AVENUE, N.W., WASHINGTON, DC, 20005, US

(73) Assignee: THE INDUSTRY & ACADEMIC COOPERATION IN CHUNGNAM NATIONAL UNIVERSITY (IAC), Daejeon (KR)

(21) Appl. No.: 12/329,702

(22) Filed: Dec. 8, 2008

(30) Foreign Application Priority Data
Apr. 30, 2008 (KR) 10-2008-40642

(51) Int. Cl. H04W 84/12

(52) U.S. Cl. 370/338

(57) ABSTRACT

A method and apparatus for dynamically distributing traffic in a channel bonding wireless local area network (LAN) system. The method includes extracting information regarding a flow from an arrived packet and classifying the packet in the unit of the flow based on the extracted flow information; monitoring the state of each of bonded channels; and allocating the flow sorted in the extracting to the optimum channel by referring to information regarding the channel state monitored in the monitoring.

### CROSS-REFERENCE TO RELATED APPLICATIONS

This application claims the benefit under 35 U.S.C. §119(a) of Korean Patent Application No. 10-2008-40642, filed in the Korean Intellectual Property Office on Apr. 30, 2008, the entire disclosure of which is incorporated herein by reference.

### BACKGROUND OF THE INVENTION

1. Field of the Invention

The present invention relates to a method and apparatus for dynamically distributing traffic in a channel bonding wireless local area network (LAN) system, and more particularly, to a data transfer method and apparatus in which when packets are transmitted through the simultaneous use of a plurality of channels in a wireless LAN, signal quality and data transfer efficiency and the like of the wireless LAN are detected so as to allow traffic as much as possible to be sent to a channel with better signal quality rather than a channel with worse signal quality, thereby improving the entire data throughput.

2. Background of the Related Art

In general, a wireless local area network (LAN) (hereinafter, referred to as ‘LAN’) is an LAN technology that supports the 802.11a/b/g standard established by the IEEE. The wireless LAN is both a technology and an apparatus that enables the terminals such as notebook computers, PDAs, cellular phones or the like, each equipped with a wireless LAN interface to wirelessly be connected to an access point (AP) and the like. The wireless LAN serves to support an infrastructure mode in which a plurality of wireless LANs is connected to each other by means of an access point so as to communicate with each other, or an ad-hoc mode in which a plurality of devices is connected to each other by means of wireless LAN interfaces equipped therein so as to communicate together.

The 802.11a/b/g standard can use both 2.4 GHz and 5 GHz radio frequency bands without any permission so as to enable a wireless LAN environment to be easily and readily constructed. 802.11a supports a maximum data rate of 54 Mbps in the 5 GHz radio frequency band, 802.11b supports a maximum bit rate of 11 Mbps in the 2.4 GHz radio frequency band, and 802.11g supports a maximum data rate of 54 Mbps in the 2.4 GHz radio frequency band. The current 802.11n being established is scheduled to support a maximum data rate of 300 Mbps in the 2.4 GHz and 5 GHz radio frequency bands.

In the 802.11, an available frequency band is divided into a plurality of channels. It is possible to use 13 channels in the 2.4 GHz radio frequency band and 19 channels in the 5 GHz radio frequency band. The 802.11b/g has three non-redundant channels that can be used simultaneously without interference between channels, and the 802.11a has 12 non-redundant channels. Using such characteristics, the 802.11n supports a channel bonding function of concurrently employing multiple non-redundant channels to improve a data transfer rate.

In wireless communication systems, fault tolerance can be prepared for a fault of a network card such as a wireless LAN card, or a plurality of wireless LAN cards can be combined together by a single IP at a node for the purpose of traffic load balancing to improve wireless communication speed, which is called channel bonding.

The use of the channel bonding function enables improvement of data transfer rate, but it is disadvantageously difficult to always expect a stable signal quality in terms of the characteristics of a radio electromagnetic wave. That is, a wireless LAN, when bonded channels are used, respective channels employs different frequency bands. Thus, the state of a radio signal of each channel may be different every channel. In addition, the radio signal state of each channel is in direct relation with the amount of traffic allocated to each channel. In other words, when more traffic is concentrated to a specific channel, the radio signal state of the channel may be exacerbated. Especially, the reason for this is because when traffic is transmitted in a channel bonding environment, packets contained in an identical flow must make use of the same wireless channel. When the packets contained in the identical flow are transmitted through different wireless channels, the order of the packets is reversed, leading to a degradation in performance of application.

### SUMMARY OF THE INVENTION

Accordingly, the present invention has been made in an effort to solve the aforementioned problems associated with the prior art, and it is an object of the present invention to provide a method and apparatus in which when traffic is transmitted by using a channel bonding function in a wireless LAN, the states of a plurality of wireless channels are monitored and the traffic is dynamically controlled by using information on the monitored state of the wireless LAN interface, thereby improving the entire transfer efficiency.

To accomplish the above object, according to the present invention, there is provided a method and apparatus for dynamic distribution of traffic in a channel bonding wireless LAN system.

(1) Dynamic Traffic Distribution Method

The present invention is directed to a method for dynamically distributing traffic in a channel bonding wireless LAN system, the method including the steps of:

(A) extracting information regarding a flow from an arrived packet and classifying the packet in the unit of the flow based on the extracted flow information;

(B) monitoring the state of each of bonded channels; and

(C) allocating the flow sorted in the step (A) to the optimum channel by referring to information regarding the channel state monitored in the step (B).

In the above step (A) of the present invention, preferably, the flow information may include information regarding a source IP address, a destination IP address, a source port number, a destination port number, a protocol, a flow start time, a final update time, the number of packets, the number of bytes, an input interface and an output interface.

In the above step (B) of the present invention, preferably, the state information may be periodically monitored which includes a maximum data rate, a current traffic amount, a current link utilization ratio and a current transmission error rate for each channel.

In the above step (C) of the present invention, preferably, the method may be programmed in such a fashion that the flow is allocated to a channel which is high in the maximum data rate, or a channel which is low in the current traffic amount, the current link utilization ratio or the current transmission error rate.

(2) Dynamic Traffic Distribution Apparatus

Also, the present invention is directed to an apparatus for dynamically distributing traffic in a channel bonding wireless LAN system, the apparatus including:

a flow-classifying section for extracting information regarding a flow from an arrived packet and classifying the packet in the unit of the flow based on the extracted flow information;

a channel state-monitoring section for monitoring the state of each of bonded channels; and

a flow-allocating section for allocating the flow sorted by the flow-classifying section to the optimum channel by referring to information regarding the channel state monitored by the channel state-monitoring section.

In the present invention, preferably, the flow information may include information regarding a source IP address, a destination IP address, a source port number, a destination port number, a protocol, a flow start time, a final update time, the number of packets, the number of bytes, an input interface and an output interface.

In the present invention, preferably, the channel state-monitoring section may periodically monitor the state information which includes a maximum data rate, a current traffic amount, a current link utilization ratio and a current transmission error rate for each channel.

In the present invention, preferably, the flow-allocating section may be programmed in such a fashion that the flow is allocated to a channel which is high in the maximum data rate, or a channel which is low in the current traffic amount, the current link utilization ratio or the current transmission error rate.

The apparatus according to the present invention may be applied to a wireless LAN host equipped with a plurality of wireless LAN cards, a wireless LAN access point or a wireless LAN mesh node.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a diagrammatical view illustrating an example of a communication network environment to which a method and apparatus for dynamic distribution of traffic in a channel bonding wireless LAN system according to the present invention can be applied;

FIG. 2 is a schematic block diagram illustrating an example of an apparatus for dynamic distribution of traffic in a channel bonding wireless LAN system according to the present invention; and

FIG. 3 is a schematic block diagram illustrating a structure in which packets are transmitted in an apparatus for dynamic distribution of traffic in a channel bonding wireless LAN system according to the present invention.

### DETAILED DESCRIPTION OF THE PREFERRED EMBODIMENT

Reference will now be made in detail to a preferred embodiment of the present invention with reference to the attached drawings.

Reference will now be made in detail to a preferred embodiment of the present invention with reference to the attached drawings.

In the present invention, a flow-classifying step (or flow-classifying section) inputs five fields including a source IP address, a destination IP address, a source port number, a destination port number and a protocol among header information of input packets to a hash function to create information regarding a flow and records the created flow information in a flow information database (DB).

If the flow information of a newly arrived packet does not exist in the flow information DB, the flow information of an associated packet is stored in the flow information DB. The flow information DB has information regarding a flow start time, a final update time, the five fields in the header, the number of packets, the number of bytes, an input interface and an output interface, which are stored therein. When existing flow information is searched, an associated flow information DB is updated. If a packet of an associated flow does not arrive after the elapse of a predetermined time period, associated flow information is deleted from the flow information DB.

In the present invention, a channel state-monitoring step (or channel state-monitoring section) periodically monitors the state information which includes a maximum data rate, a current traffic amount, a current link utilization ratio, a current transmission error rate and the like for each of a plurality of wireless LAN channels, and stores the monitored state information in a channel state database (DB).

In the present invention, a flow-allocating step (or flow-allocating section) allocates the sorted flow to an optimum channel among the plurality of channels to transmit traffic. For a newly started flow, a packet is transmitted to a channel which is low in both the current link utilization ratio and the current transmission error rate among the plurality of channels so as to increase the link utilization ratio of the channel, thereby improving the entire data throughput.

In addition, the values of the current transmission error rate or the current link utilization ratio are periodically compared with predetermined reference values to cause flows allocated to a channel which is high in the current transmission error rate or the current link utilization ratio to be transported to a channel which is low in both the current link utilization ratio and the current transmission error rate. In other words, some of the flows allocated to a channel having a higher current link utilization ratio are transported to another channel having a lower current link utilization ratio. The conditions where the flow is transported are set as follows: the case where the current transmission error rate or current link utilization ratio of a specific channel is greater than a predetermined reference value. That is, on a basis of the bit rate of flows allocated to a channel that it is desired to transport a flow, flows having a higher bit rate are preferentially selected to be transported to another channel. The conditions where a specific flow is transported require that the sum of a current link utilization ratio of a channel for the flow to be transported and a bit rate value of the flow being transported should be smaller than a predetermined value. If there is a channel satisfying such conditions, flows can be continuously transported to the channel to allow the current link utilization ratio of a channel with a problem to be smaller than a predetermined value.

Now, the present invention will be described in more detail hereinafter with reference to the accompanying drawings. However, these drawings are merely illustrative for the sake of easily explaining the content and scope of the technical spirit of the present invention, and do not limit or modify the technical scope of the present invention. In addition, it will be apparent to those skilled in the art that various modification and variations can be made without departing from the technical spirit or scope of the present invention based on the illustrative drawings

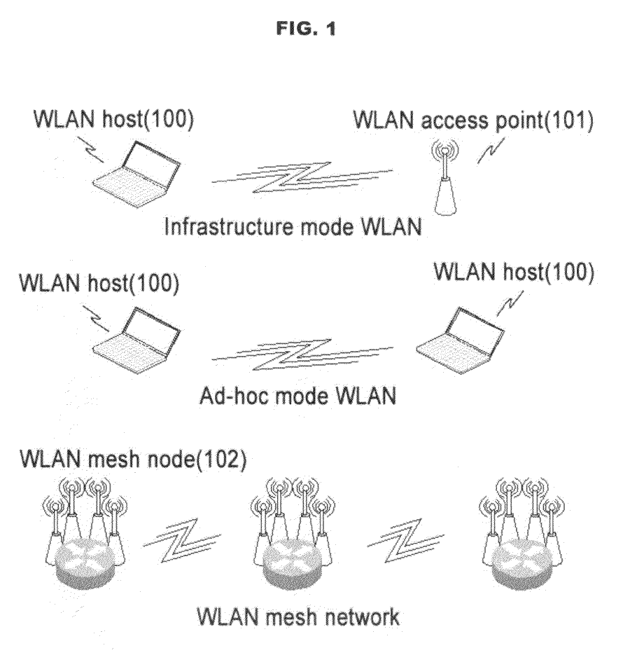

FIG. 1 is a diagrammatical view illustrating three exemplary scenarios of a communication network environment to which a method and apparatus for dynamic distribution of traffic in a channel bonding wireless LAN system according to the present invention can be applied.

As shown in FIG. 1, the method and apparatus according to the present invention can be applied to the following three cases so as to enhance a data rate: a first case where in a channel bonding WLAN infrastructure mode, the inventive apparatus is connected to a plurality of wireless LAN hosts 100 and a wireless LAN access point 101, a second case where in an ad-hoc mode, the inventive apparatus is connected to a plurality of wireless LAN hosts 100, and a third case where the inventive apparatus is connected to a wireless LAN mesh node 102 for allowing packets to be rapidly transmitted.

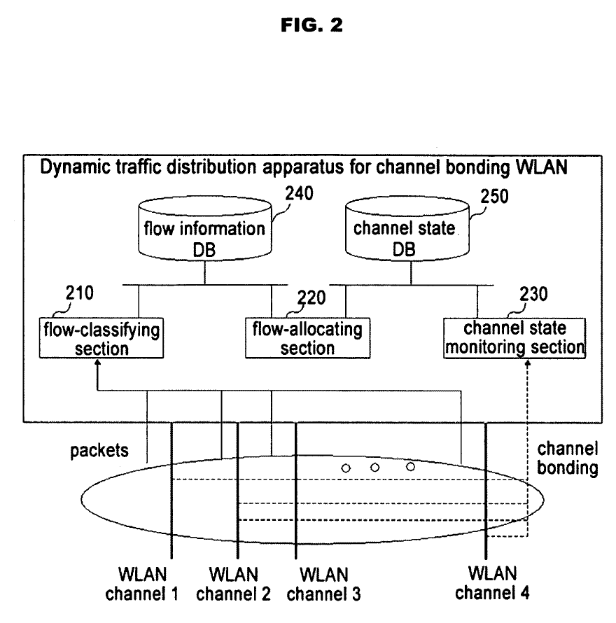

FIG. 2 is a schematic block diagram illustrating an example of an apparatus for dynamic distribution of traffic in a channel bonding wireless LAN system according to the present invention.

Referring to FIG. 2, there is shown an apparatus for dynamically distributing traffic at a host, an access point or a mesh node in a wireless LAN when a channel bonding is used.

When a plurality of channels is bonded or combined together, it is recognized as a virtual wireless LAN channel. When a packet arrived at the wireless LAN channel, a flow-classifying section 210 inputs five fields including a source IP address, a destination IP address, a source port number, a destination port number and a protocol as header information of the arrived packet to a hash function to create information regarding a flow and records the created flow information or newly creates flow information in a flow information DB 240. In this case, if the flow is identical to an existing flow, associated flow information is updated. The flow information DB 240 stores flow information regarding a flow start time of each flow, a final update time, the five fields in the header, the number of packets, the number of bytes, an input interface and an output interface. Using the flow information of the arrived packet, when existing flow information is searched in the flow information DB 240, associated flow information is updated. If a packet of an associated flow does not arrive at the wireless LAN channel after the elapse of a predetermined time period, associated flow information is deleted from the flow information DB 240.

A channel state-monitoring section 230 periodically monitors the channel state and records the state information which includes a maximum data rate, a current traffic amount, a current link utilization ratio, a current transmission error rate and the like for each of a plurality of wireless LAN channels in a channel state database DB 250.

A flow-allocating section 220 (C) allocates the flows currently recorded in the flow information DB 240 to appropriate wireless LAN channels by referring to the channel state information stored in the channel state DB 250. For a newly arrived flow, a channel is selected which is low in both the current link utilization ratio and the current transmission error rate among a plurality of channels and then a packet is transmitted to the selected channel. This increases the link utilization ratio of the channel, leading to an improvement in the entire data throughput.

However, since respective flows have a packet rate and a bit rate which are not identical to each other, and flow duration time intervals which are different from each other, it is required that the channel state be monitored to allow traffic to be re-distributed. In the re-distribution of the traffic, the values of the current transmission error rate or the current link utilization ratio of each channel are compared with the predetermined reference values using the channel state DB 250 containing the periodically monitored channel state information, so that flows allocated to a channel which is high in the current transmission error rate or the current link utilization ratio can be transported to a channel which is low in both the current link utilization ratio and the current transmission error rate. In this case, it is required that the sum of a current link utilization ratio of a channel for the flow to be transported and a bit rate value of the flow being transported should be smaller than a predetermined value.

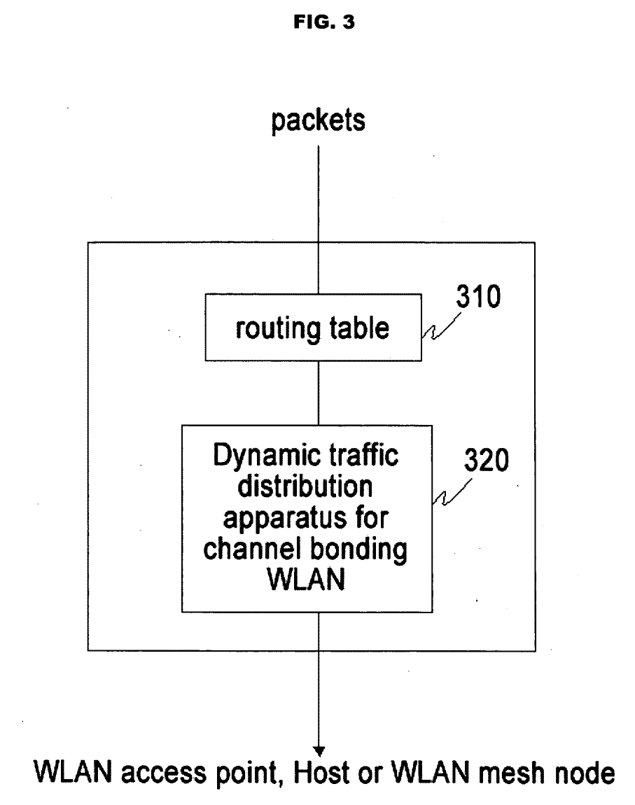

FIG. 3 is a schematic block diagram illustrating a structure in which packets are transmitted in an apparatus for dynamic distribution of traffic in a channel bonding wireless LAN system according to the present invention.

When a packet arrives at a channel bonding wireless LAN node, a destination IP address of the packet is searched for from a routing table 310 so as to obtain interface information to be transmitted. At this time, the interface is a virtual logical interface which is allocated with only one IP address and bonds or combines a plurality of physical wireless LAN channels together into a single channel. Thus, the virtual logical interface for the packet to be delivered is mapped to one of the plurality of physical interfaces in a dynamic traffic distribution apparatus 320 based on wireless LAN (WLAN) channel bonding. Each physical interface is allocated with wireless LAN channel information.

As described above, according to the present invention, a wireless LAN access point or host employing a plurality of wireless LAN channels improves a wireless link speed using channel bonding, traffic is dynamically allocated depending on the quality of a radio signal, thereby reducing a transmission error rate and increasing the entire traffic rate.

In addition, in the case where the channel bonding is used, when a wireless link connection is established between an access point and an access point or between a host and a host, or a wireless LAN mesh network is connected to a mesh node, traffic is dynamically allocated depending on the quality of a radio signal, thereby enabling stable and efficient traffic transmission.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A method for dynamically distributing traffic in a channel bonding wireless local area network (LAN) system, the method comprising:
extracting information regarding a flow from an arrived packet and classifying the packet in the unit of the flow based on the extracted flow information;
monitoring the state of each of bonded channels; and
allocating the flow sorted in the extracting to the optimum channel by referring to information regarding the channel state monitored in the monitoring.

2. The method according to claim 1, wherein the flow information includes information regarding a source IP address, a destination IP address, a source port number, a destination port number, a protocol, a flow start time, a final update time, the number of packets, the number of bytes, an input interface and an output interface.

3. The method according to claim 1, wherein in the monitoring the state information is periodically monitored which includes a maximum data rate, a current traffic amount, a current link utilization ratio and a current transmission error rate for each channel.

4. The method according to claim 3, wherein in the allocating, the flow is allocated to a channel which is high in the maximum data rate, or a channel which is low in the current traffic amount, the current link utilization ratio or the current transmission error rate.

5. An apparatus for dynamically distributing traffic in a channel bonding wireless local area network (LAN) system, the apparatus comprising:
a flow-classifying section to extract information regarding a flow from an arrived packet and to classify the packet in the unit of the flow based on the extracted flow information;
a channel state-monitoring section to monitor the state of each of bonded channels; and
a flow-allocating section to allocate the flow sorted by the flow-classifying section to the optimum channel by referring to information regarding the channel state monitored by the channel state-monitoring section.

6. The apparatus according to claim 5, wherein the flow information includes information regarding a source IP address, a destination IP address, a source port number, a destination port number, a protocol, a flow start time, a final update time, the number of packets, the number of bytes, an input interface and an output interface.

7. The apparatus according to claim 5, wherein the channel state-monitoring section periodically monitors the state information which includes a maximum data rate, a current traffic amount, a current link utilization ratio and a current transmission error rate for each channel.

8. The apparatus according to claim 7, wherein the flow-allocating section allocates the flow to a channel which is high in the maximum data rate, or a channel which is low in the current traffic amount, the current link utilization ratio or the current transmission error rate.

9. The apparatus according to claim 5, which is applied to a wireless LAN host equipped with a plurality of wireless LAN cards, a wireless LAN access point or a wireless LAN mesh node.

10. The method according to claim 2, wherein in the monitoring the state information is periodically monitored which includes a maximum data rate, a current traffic amount, a current link utilization ratio and a current transmission error rate for each channel.

11. The apparatus according to claim 6, wherein the channel state-monitoring section periodically monitors the state information which includes a maximum data rate, a current traffic amount, a current link utilization ratio and a current transmission error rate for each channel.

12. The apparatus according to claim 6, which is applied to a wireless LAN host equipped with a plurality of wireless LAN cards, a wireless LAN access point or a wireless LAN mesh node.
